(19) United States
(12) Patent Application Publication
(10) Pub. No.: US 2023/0226640 A1
(43) Pub. Date: Jul. 20, 2023

(54) LASER PROCESSING HEAD HAVING WIDE RANGE ZOOM

(71) Applicant: II-VI Delaware, Inc., Wilmington, DE (US)

(72) Inventor: Axel Heinrici, Kleinmachnow (DE)

(21) Appl. No.: 17/579,917

(22) Filed: Jan. 20, 2022

(51) Int. Cl. B23K 26/06; G02B 27/30; B23K 26/046

(52) U.S. Cl. CPC B23K 26/0648; G02B 27/30; B23K 26/046

(57) ABSTRACT

A laser processing head directs laser energy along an optical axis from a fiber to perform brazing or welding operations. A collimating stage collimates a diverging beam of the laser energy from the fiber into a collimated beam, and a focusing stage focuses the collimated beam into a converging beam to a focus spot for the desired operation. At least one of the stages has a changeable effective focal length for zoom functionality. A freeform refractive optic can be positioned in at least one of the diverging and collimated beams. For example, a freeform refractive optic in a first position is placed out of the diverging beam. However, the freeform refractive optic in a second position placed in the diverging beam can field map or intensity map the diverging beam to produce the mapped diverging beam, which increases an image of the fiber tip to the collimating stage.

### BACKGROUND OF THE DISCLOSURE

Laser processing heads can have a zoom functionality that uses lenses with variable effective focal length. In most laser processing heads, the zoom functionality is integrated into the collimator of the optical system. Moving the lenses in the collimator changes the magnification that can be achieved. This in turn changes the beam diameter inversely proportional to the magnification. In high-power laser applications, the permissible power density that can be handled safely puts an upper limit on what zoom range can be achieved.

What is needed is an optical system for a laser processing head that can offer zoom ranges that cover both deep penetration welding and brazing without the need for the optical fiber to be changed and without losing zoom capabilities. To that end, the subject matter of the present disclosure is directed to overcoming, or at least reducing the effects of, one or more of the problems set forth above.

### SUMMARY OF THE DISCLOSURE

A laser processing head disclosed herein is used for directing laser energy along an optical axis from a fiber tip. The head comprises a collimating stage, a focusing stage, and a freeform refractive optic. The collimating stage is disposed along the optical axis and is configured to collimate a diverging beam of the laser energy from the fiber tip into a collimated beam. The focusing stage is disposed along the optical axis and is configured to focus the collimated beam from the collimating stage into a converging beam to a focus spot. At least one of the collimating stage and the focusing stage has a changeable effective focal length.

The freeform refractive optic is positionable in the optical axis between the fiber and the collimating stage. The freeform refractive optic in a first position is placed out of the diverging beam. The freeform refractive optic in a second position is placed in the diverging beam and is configured to map the diverging beam by a defined mapping. The defined mapping is configured to increase an image of the fiber tip imaged in the diverging beam to the collimating stage.

A laser processing head disclosed herein is used for directing laser energy along an optical axis from a fiber tip. The head comprises a collimating stage, a focusing stage, and at least one freeform refractive optic. The collimating stage of an optical system is disposed along the optical axis and is configured to collimate a diverging beam of the laser energy from the fiber tip into a collimated beam. The focusing stage of the optical system is disposed along the optical axis and is configured to focus the collimated beam from the collimating stage into a converging beam to a focus spot. At least one of the collimating stage and the focusing stage has a changeable effective focal length.

The at least one freeform refractive optic is positionable in the optical axis in at least one beam of the diverging beam and collimated beam. The at least one freeform refractive optic in a first position is placed out of the at least one beam. The at least one freeform refractive optic in a second position is placed in the at least one beam and is configured to map the at least one beam by a defined mapping. The defined mapping is configured to increase an image of an up-axis portion of the optical system imaged in the beam to a down-axis portion of the optical system.

A method is disclosed herein of laser processing using laser energy from a fiber tip. In a collimating stage, a diverging beam of the laser energy from the fiber tip is collimated into a collimated beam. The collimated beam is focused in a focusing stage into a converging beam to a focus spot. A changeable focal length of at least one of the collimating stage and the focusing stage is changed. Operating in a first condition under the changeable effective focal length, a freeform refractive optic is placed out of the optical axis between the fiber tip and the collimating stage to produce a first range of sizes of the focus spot. Operating in a second condition under the changeable effective focal length, the freeform refractive optic is placed in the optical axis between the fiber tip and the collimating stage. An image of the fiber tip imaged in the diverging beam to the collimating stage is increased by mapping the diverging beam by a defined mapping to produce a second range of sizes of the focus spot.

The foregoing summary is not intended to summarize each potential embodiment or every aspect of the present disclosure.

### BRIEF DESCRIPTION OF THE DRAWINGS

FIG. 1 illustrates a laser delivery system according to the present disclosure.

FIG. 2 schematically illustrates a laser processing head according to the present disclosure.

FIG. 3A schematically illustrates the optical system of the laser processing head operated to collimate the laser beam to a first example spot size.

FIG. 3B schematically illustrates the optical system of FIG. 3A with a freeform refractive optic disposed in the diverging beam from the input fiber.

FIG. 4A schematically illustrates the optical system operated to collimate the laser beam to a second example spots size.

FIG. 4B schematically illustrates the optical system of FIG. 4A with the freeform refractive optic disposed in the diverging beam from the input fiber.

FIG. 5 schematically illustrates another optical system of the laser processing head.

FIG. 6 schematically illustrates yet another optical system of the laser processing head.

### DETAILED DESCRIPTION OF THE DISCLOSURE

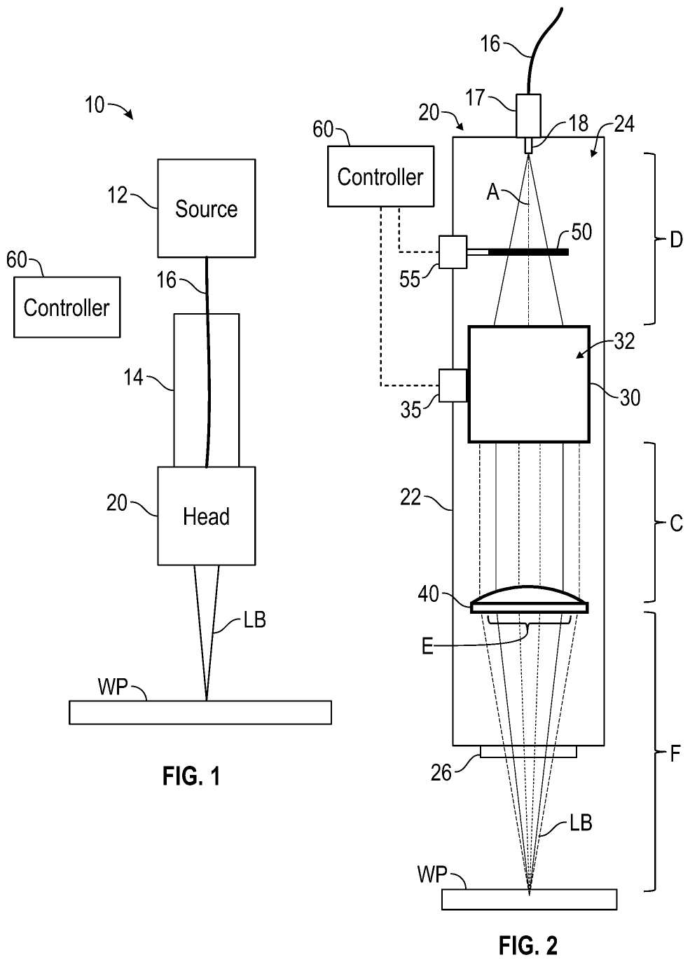

FIG. 1 illustrates a laser delivery system 10 according to the present disclosure. A laser source 12 generates high-power laser light that is propagated along a fiber optic cable 16 to a laser processing head 20. The laser source 12 can be any suitable multi-mode or a single-mode laser depending on the laser power required.

The laser processing head 20 can be moved relative to a workpiece WP and/or can have the workpiece WP moved relative to it. For example, the laser processing head 20 can be moved by a gantry system, robotic arm, or other apparatus 14 used in the art. Internally, the laser processing head 20 includes optics to focus the laser energy in a laser beam LB to the workpiece WP, and the laser processing head 20 can be used for cutting, brazing, welding, additive manufacturing, or some other lasing process. A control unit 60 can be used to control the operation of components of the system 10, such as in the manner discussed below.

FIG. 2 schematically illustrates a laser processing head 20 according to the present disclosure. The laser processing head 20 includes a housing 22 for an internal optical system 24. A delivery fiber 18, such as from a fiber optic cable 16 connected to a cable receiver 17, conducts the laser light into the interior of the head 20. A cover slide 26 disposed in the housing 22 can protect the internal optical system 24 from contamination, making a clean space in the interior of the housing 22.

The internal optical system 24 includes a collimation stage 30 and a focusing stage 40. As shown here, the optical system 24 is a zoom-collimator system 32 in which the collimation stage 30 can be used to change the focal length of the laser beam LB. Although the present zoom system includes the zoom collimation stage 30, the teachings of the present disclosure can apply to other zoom systems because the relationship between exit-beam-diameter and magnification is true for other systems. In other examples, the collimation stage 30, the focusing stage 40, or both can be configured to change the focal length of the laser beam LB. In some less common zoom systems, the collimation and focusing are provided in a single optical group or even a single optical element. Again, the teachings of the present disclosure can apply to these types of zoom systems as well.

During operation, the delivery fiber 18 emits high-power laser light in the housing's interior. The laser light conducted by the fiber 18 exits the fiber facet at the fiber tip, and the laser light passes in a divergent beam (D) to the zoom collimation stage 30, which uses one or more lenses of the zoom-collimator system 32 to collimate the laser light. From the collimation stage 30, the laser light passes in a collimated beam (C) to the focusing stage 40, which has one or more lenses to focus the collimated light. The laser light has an exit beam diameter (E) when exiting the focusing stage 40 and converges in a converging beam (F) to a focus spot for impinging on the workpiece WP. The focused laser beam LB emitted from the housing 22 can achieve the purposes of the laser process, such as welding, additive manufacture, cutting, etc.

As will be appreciated, the laser processing head 20 can include additional components not necessarily shown, such as turning mirrors, cover slides, sensors, etc. As will be appreciated, the zoom collimation stage 30 uses a zoom-collimator system 32 that has two or more lenses that are movable along the optical axis A. One or more lens actuators 35 controlled by the controller 60 can move the collimation lenses in the zoom collimator system 32 so that different effective focal lengths can be achieved using the zoom-collimator system 32. This produces different exit-beam diameters (E) from the focusing stage 40. Overall, the exit beam diameter (E) is proportional to 1/Magnification produced. Thus, a larger magnification produces a smaller exit beam diameter (E).

The present optical system 24 for the laser processing head 20 can offer zoom ranges that cover both deep penetration welding operations and brazing operations without the need for the optical fiber 18 to be changed and without losing zoom capabilities. In the present optical system 24, a freeform refractive optic 50, such as a beam shaper, can be placed/removed relative to the diverging beam (D) between the facet (i.e., fiber tip) of the input fiber 18 (as an up-axis portion of the optical system 24) and the zoom collimation stage 30 (as a down-axis portion). When placed in the diverging beam (D), the freeform refractive optic 50 makes the fiber tip of the fiber 18 appear bigger to the optical system 24.

A well-suited freeform refractive optic 50 for this purpose is a Pseudo-Random Intensity Mapping Element (PRIME) beam shaper available from PowerPhotonic of the U.K. The PRIME beam shaper is made of an optical material, such as fused silica, and has a non-uniform surface in the material. Preferably, the freeform refractive optic 50 used according to the present disclosure is configured to diverge the diverging beam (D) at an additional divergence angle that is predetermined. Additionally, the freeform refractive optic 50 can be configured to shape the distribution of the laser's intensity as desired. Yet, the freeform refractive optic 50 preferably does not require overly precise alignment to the divergent beam (D) to achieve the additional divergence.

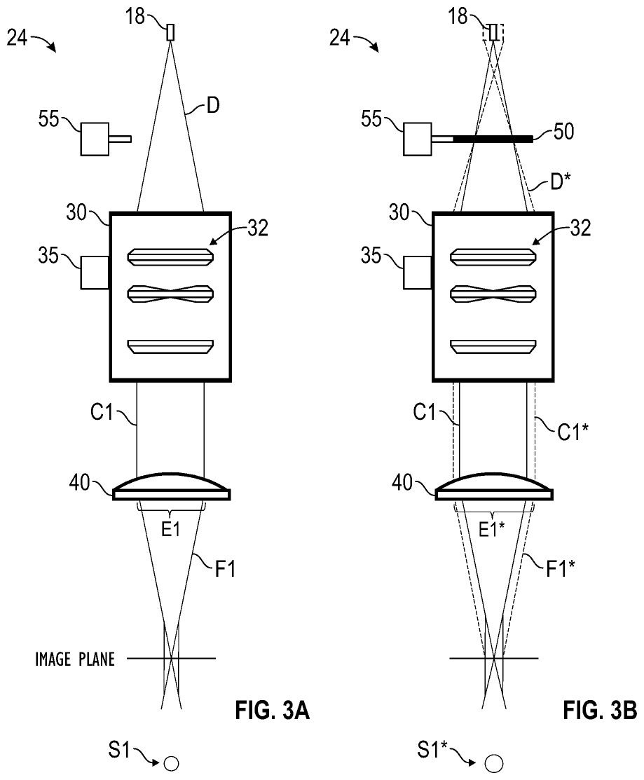

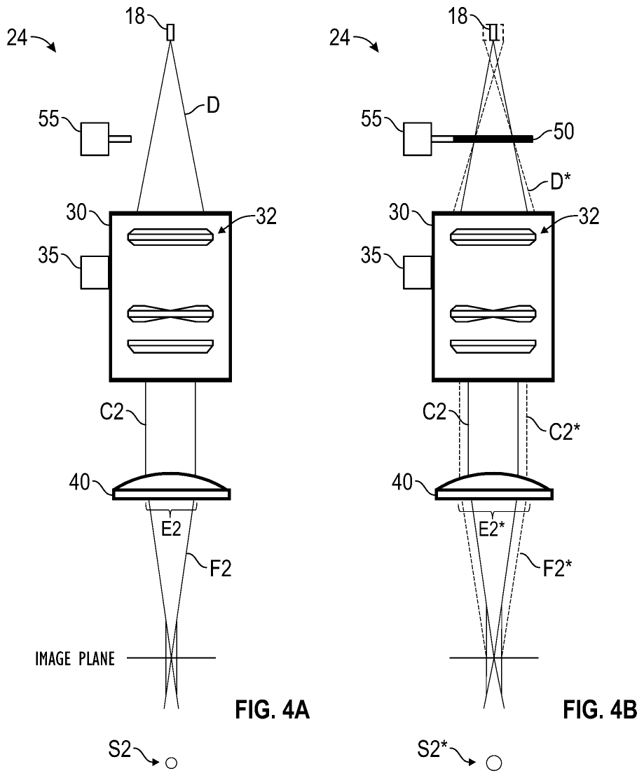

Discussion of how the freeform refractive optic 50 can offer zoom ranges that cover both deep penetration welding operations and brazing operations are discussed below with reference to FIGS. 3A-3B and 4A-4B.

FIG. 3A schematically illustrates the optical system 24 operated at a first zoom setting to collimate the laser beam to a first example spot size (S1) without the use of the freeform refractive optic 50. By contrast, the optical system 24 in FIG. 3B is operated at the same first zoom of FIG. 3A to collimate the laser beam, but the freeform refractive optic 50 is used to produce an expanded spot size (S1*). Likewise, FIG. 4A schematically illustrates the optical system 24 operated at a second zoom setting to collimate the laser beam to a second spot size (S2) without the use of the freeform refractive optic 50. By contrast, the optical system 24 in FIG. 4B is operated at the same second zoom of FIG. 4A to collimate the laser beam, but the freeform refractive optic 50 is used to produce an expanded spot size (S2*). As will be appreciated, the diameter of the spot size (S) is generally given by the facet diameter (i.e., fiber tip) of the input fiber 18 times the magnification of the optical system 24.

As shown in FIG. 3A with the freeform refractive optic positioned out of the free space, the diverging beam (D) from the input fiber 18 is collimated by zoom-collimator system 32 in the zoom collimation stage 30. As noted, one or more lenses of the system 32 can be movable using one or more appropriate actuators 35. The collimated beam (C1) is then focused by the focusing stage 40 (having one or more lenses) to produce a converging beam (F1) to a first spot size (S1). As already noted, the exit beam diameter (E1) is proportional to 1/Magnification produced, and the diameter of the spot size (S1) is generally given by the diameter of the facet or tip of the input fiber 18 times the magnification of the optical system 24.

By contrast, FIG. 3B shows the freeform refractive optic 50 disposed in the diverging beam (D) from the input fiber 18. For example, an actuator 55 can move the freeform refractive optic 50 into the diverging beam (D). Because the freeform refractive optic 50 does not require extremely high positioning accuracy relative to the fiber's facet, the optic 50 can be inserted into (and removed from) the diverging beam (D) by an actuator 55 having simple mechanics. Accordingly, the actuator 55 can use any appropriate mechanisms, such as a piezoelectric device, an electric solenoid, bearings, gears, rotating hinges, pneumatic operators, and the like.

As such, the freeform refractive optic 50 can be stored in the clean space of the housing for the head (20) and can be positioned (pivoted, rotated, or turned) into (and out of) the free space between the fiber 18 and the zoom collimating stage 30. The freeform refractive optic 50 is configured to field map or intensity map the diverging beam (D) to produce a mapped diverging beam (D*) that is predefined by the characteristics of the optic 50. There is a very small change in divergence from the diverging beam (D) to the mapped diverging beam (D*). However, the “field mapping” or “intensity mapping” provided by the freeform refractive optic 50 changes the focused spot diameter by making the fiber tip 18 appear larger to the optical system 24. For instance, an example laser beam may have a half cone angle of 80 mrad to 125 mrad (0.08 to 0.125 radians) depending on diameter definition. A freeform refractive optic, such as used in the disclosed system 24, may increase that half cone angle by less than 10-mrad while causing the focused spot diameter to increase by a factor of 5. Thus, the freeform refractive optic 50 of the present disclosure increases the image of the fiber tip of the input fiber 18 to the collimating stage 30 by mapping the diverging beam (D) in a way that makes the diameter of the fiber tip of the input fiber 18 appear larger to the zoom collimating stage 30. In turn, the zoom collimating stage 30 collimates the mapped diverging beam (D*) at the same zoom as in FIG. 3A. However, the resulting collimated beam (C1*) is focused by the focusing stage 40 (having one or more lenses) with a larger exit beam diameter (E1*) to produce a converging beam (F1*) with an expanded spot size (S1*).

FIGS. 4A-4B show comparable operations of the optical system 24, but with the zoom-collimator system 32 in the zoom collimating stage 30 at a different zoom setting. As shown in FIG. 4A with the freeform refractive optic 50 positioned out of the free space, the diverging beam (D) from the input fiber 18 is collimated by the zoom-collimator system 32 in the zoom collimating stage 30. One or more lenses in the system 32 are moved using the one or more appropriate actuators 35 to a different zoom setting than used in the example of FIG. 3A. The collimated beam (C2) is then focused by the focusing stage 40 (having one or more lenses) to produce a converging beam (F2) with a second spot size (S2). In this example, the exit beam diameter (E2) is smaller than in FIG. 3A, and the spot size (S2) is smaller than in FIG. 3B.

By contrast, FIG. 4B shows the freeform refractive optic 50 disposed in the diverging beam (D) from the input fiber 18. The freeform refractive optic 50 is configured to field map or intensity map the diverging beam (D) to produce the mapped diverging beam (D*) that is predefined by a defined mapping of the freeform refractive optic 50. As a result, the diameter of the fiber tip of the input fiber 18 appears larger to the zoom collimating stage 30, which collimates the mapped diverging beam (D*) at the same zoom as in FIG. 4A. The resulting increased collimated beam (C2*) is then focused by the focusing stage 40 (having one or more lenses) with the exit beam diameter (E2*) to produce a converging beam (F2*) with an expanded spot size (S2*).

As shown in the arrangements above, the freeform refractive optic 50 is placed adjacent the fiber 18 without any additional optics disposed therebetween. In this way, the freeform refractive optic 50 can increase an image of the fiber tip of the fiber 18 by making the facet diameter of the tip of the fiber 18 appear larger to the optical system 24, which can then further zoom the optical beam. For example, in one configuration, the freeform refractive optic 50 can make a 200 μm Ø fiber appear as a 1000 μm Ø fiber to the rest of the optical system 24. As noted above, this can allow the optical system 24 with a given zoom range to operate in a first configuration for zooming the originally imaged 200 μm Ø fiber in the given zoom range and to operate alternatively in a second configuration for zooming the larger imaged 1000 μm Ø fiber in the given zoom range. A very broad range of spot diameters (S) can therefore be achieved using the given zoom range of the optical system 24.

As can be seen, the optical system 24 can be used in the first configuration of FIGS. 3A and 4A with the freeform refractive optic placed out of the diverging beam (D), and the optical system 24 can be used in a second configuration of FIGS. 3B and 4B with the freeform refractive optic placed in the diverging beam (D). Accordingly, using these two configurations (with or without the freeform refractive optic 50), the focused spot diameter (S) can be tuned by the zoom collimating stage 30. In this way, the zoom of the optical system 24 can be switched between two ranges by placing or removing the freeform refractive optic 50 in the diverging beam (D). One range can be suited for brazing operations, while the other range can be used for deep penetration welding.

In brazing, for example, the focused spot (S) is used to heat a filler metal placed adjacent faying surfaces to be joined so that the filler metal melts and fills the gap between the faying surfaces by capillary action. A larger spot size (S) with an increased diameter is suited for this type of operation. By contrast, in deep penetration welding, the focused spot (S) from the laser beam delivers high power density to melt metal to be welded. A smaller spot size (S) with a decreased diameter is suited for this type of operation. These two operations, therefore, differ greatly in execution. A typical zoom collimating stage for a laser processing head has a zoom factor of 3× or 4×. For the laser processing head 20 to be used for both brazing and welding, the freeform refractive optic 50 can be used to give the optical system 24 of the present disclosure a zoom factor of about 7× or 8×. Depending on the laser processing head, power densities, and other general factors, the zoom range of the disclosed optical system 24 to cover deep penetration welding can produce spot sizes of about 0.3 to 0.8-mm Ø, and the zoom range of the disclosed optical system 24 to cover brazing can produce spot sizes of about 1.7 to 4-mm Ø.

As an example, the spot sizes S1 and S2 can range between about 0.3 mm to 0.8 mm when the freeform refractive optic 50 is not positioned in the diverging beam (D), whereas the spot sizes S1* and S2* can range between about 1.6 mm to 3.8 mm when the freeform refractive optic 50 positioned in the diverging beam (D) to produce the mapped diverging beam (D*). As will be appreciated, the spot sizes discussed here are merely provided as examples. Moreover, it will be appreciated that there are typical spot sizes used for common processes that depend on a number of variables, and the implementations of the present disclosure can be configured for those common processes and variables. For example, deep penetration welding of steel is a common process used in the industry. The process-dependent spot sizes for deep penetration welding of steel are 0.5 mm to 0.7 mm. By contrast, car-body-brazing is another common process, and the process-dependent spot sizes for car body brazing are 2.2 mm to 3.6 mm. There is no pronounced relation between laser power and spot diameter, and there are myriads of different laser processes. Therefore, the application usually dictates the spot diameter and applicable laser power range to be used, and the optical systems 24 of the present disclosure can be configured accordingly.

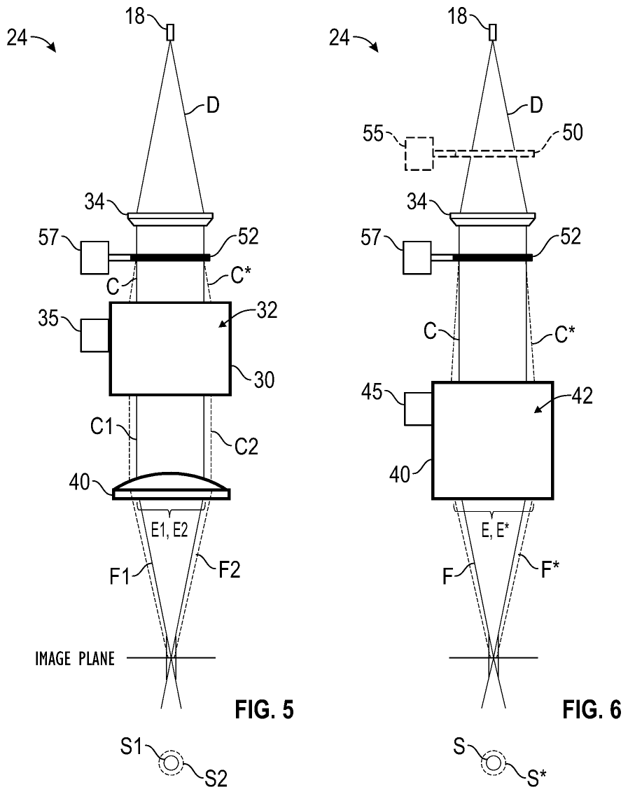

FIG. 5 schematically illustrates another optical system 24 of the present disclosure. Similar reference numerals are used for comparable components to the other configurations disclosed herein. As before, the collimating stage 30 can include a zoom collimator having optics 32, 34 and actuator(s) 35. In this configuration, however, a freeform refractive optic 52 is positioned into (and out of) a portion of the collimated beam (C) using an actuator 57.

The freeform refractive optic 52 in FIG. 5 is positioned (pivoted, rotated, or turned) into the free space between the initial collimating lens 34 (as an up-axis portion) and other lenses 32 (as a down-axis portion) of the zoom collimating stage 30. As noted, the freeform refractive optic 52 is configured to map a beam by a defined mapping. The defined mapping is configured to increase an image of an up-axis portion of the optical system 24 imaged in the beam to a down-axis portion of the optical system 24. Here, the freeform refractive optic 52 is configured to map the collimated beam (C) by the defined mapping to produce a mapped collimated beam (C*) that is predefined. As a result, the freeform refractive optic 50 in the second position is configured to increase the image of the up-axis lens 34 of the collimating stage 30 in the collimated beam (C) to the down-axis lens (32) of the collimating stage 30.

The resulting increase in the mapped collimated beam (C*) is collimated by the other lenses of the zoom-collimator system 32 to produce a collimated beam (C2). In turn, this collimated beam (C2) is then focused by the focusing stage 40 (having one or more lenses) with exit beam diameter (E2) to produce a converging beam (F2) with an expanded spot size (S2). With the removal of the freeform refractive optic 50, the original collimated beam (C) would be collimated into the original collimated beam (C1) and then focused by the focusing stage 40 with exit beam diameter (El) to produce the converging beam (F1) with the spot size (S1). Zoom functionality by the zoom-collimator system 32 in the zoom collimating stage 30 can still be performed, which allows the laser spot size (S1, S2) to be further zoomed. Accordingly, the optical system 24 of FIG. 5 can be used in a similar manner as disclosed above to perform deep penetration welding and brazing operations without the need for the optical fiber 18 to be changed and without losing zoom capabilities.

FIG. 6 schematically illustrates yet another optical system 24 of the present disclosure. Similar reference numerals are used for comparable components to the other configurations disclosed herein. In this configuration, the focusing stage 40 includes one or more movable lenses 42 moved by one or more actuator(s) 45 to alter the focus of the laser beam. The freeform refractive optic 52 is positioned into (and out of) the collimated beam (C) after a collimating lens 34 of the collimating stage 30.

In FIG. 6, the freeform refractive optic 52 is positioned (pivoted, rotated, or turned) into the free space between the collimating lens 34 (as an up-axis portion of the optical system 24) and the focusing stage 40 (as a down-axis portion). As noted, the freeform refractive optic 52 is configured to map a beam by a defined mapping. The defined mapping is configured to increase an image of an up-axis portion of the optical system imaged to a down-axis portion of the optical system. Here, the freeform refractive optic 52 is configured to map the collimated beam (C) by the defined mapping to produce a mapped collimated beam (C*) that is predefined. As a result, the freeform refractive optic 50 in the second position is configured to increase the image the up-axis lens 34 of the collimating stage 30 imaged in the collimated beam (C) to the down-axis lens (42) of the focusing stage.

The resulting mapped collimated beam (C*) is then focused by the focusing stage 40 (having one or more lenses 42) with exit beam diameter (E*) to produce a converging beam (F*) with an expanded spot size (S*). Removal of the freeform refractive optic 52 would allow the original collimated beam (C) to be focused by the focusing stage 40 with exit beam diameter (E) to produce the converging beam (F) with the spot size (S). Changes in magnification can still be performed in the focusing stage 40, which allows the laser spot (S, S*) to be further zoomed. Accordingly, the optical system 24 of FIG. 6 can be used in a similar manner as disclosed above to perform deep penetration welding and brazing operations without the need for the optical fiber 18 to be changed and without losing zoom capabilities.

This freeform refractive optic 52 in FIGS. 5-6 may be used alone to produce an added divergence to the beam (C) in the optical system 24. Alternatively, and as noted by dashed lines, this freeform refractive optics 52 may be used in conjunction with the previous configuration of the optic (50) positionable in the diverging beam (D) by an actuator (55). Both configurations may be independently operable to position the respective optic 50, 52 into (and out of) the respective beam to achieve added divergence. Accordingly, both optics 50, 52 can be used together, both optics 50, 52 can be used separately to diverge the respective beam, and both optics 50, 52 can be positioned out of the respective beam. This will allow for multiple combinations (D-C; D*-C, D*-C*, and D-C*). Although not shown, the freeform refractive optic 52 in FIG. 5 may also be used with the previous configuration of the freeform refractive optic (50) positionable in the diverging beam (D) by an actuator (55).

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A laser processing head for directing laser energy along an optical axis from a fiber tip, the head comprising:
a collimating stage disposed along the optical axis and being configured to collimate a diverging beam of the laser energy from the fiber tip into a collimated beam;
a focusing stage disposed along the optical axis and being configured to focus the collimated beam from the collimating stage into a converging beam to a focus spot, at least one of the collimating stage and the focusing stage having a changeable effective focal length; and
a freeform refractive optic being positionable in the optical axis between the fiber and the collimating stage, the freeform refractive optic in a first position being placed out of the diverging beam, the freeform refractive optic in a second position being placed in the diverging beam and being configured to map the diverging beam by a defined mapping, the defined mapping being configured to increase an image of the fiber tip imaged in the diverging beam to the collimating stage.

2. The laser processing head of claim 1, further comprising an actuator associated with the freeform refractive optic, the actuator being configured to move the freeform refractive optic between the first and second positions relative to the optical axis.

3. The laser processing head of claim 1, wherein at least the collimating stage comprises one or more lenses movable along the optical axis for the changeable effective focal length.

4. The laser processing head of claim 3, wherein the changeable effective focal length of the collimating stage having the freeform refractive optic in the first position includes a first range of the focus spot; and wherein the changeable effective focal length of the collimating stage having the freeform refractive optic in the second position includes a second range of the focus spot, the second range being different from the first range.

5. The laser processing head of claim 4, wherein the first range is configured to a deep penetration welding operation by the laser processing head, and wherein the second range is configured to a brazing operation by the laser processing head.

6. The laser processing head of claim 1, wherein at least the focusing stage comprises one or more lenses movable along the optical axis for the changeable effective focal length.

7. The laser processing head of claim 1, wherein the freeform refractive optic comprises a beam shaper having a non-uniform surface configured to diverge an incident beam at a defined divergence angle.

8. The laser processing head of claim 1, wherein the freeform refractive optic in the second position is configured to make the fiber tip appear larger to the collimating stage.

9. A laser processing head for directing laser energy along an optical axis from a fiber tip, the head comprising:
a collimating stage of an optical system disposed along the optical axis and being configured to collimate a diverging beam of the laser energy from the fiber tip into a collimated beam;
a focusing stage of the optical system disposed along the optical axis and being configured to focus the collimated beam from the collimating stage into a converging beam to a focus spot, at least one of the collimating stage and the focusing stage having a changeable effective focal length; and
at least one freeform refractive optic being positionable in the optical axis in at least one beam of the diverging beam and collimated beam, the at least one freeform refractive optic in a first position being placed out of the at least one beam, the at least one freeform refractive optic in a second position being placed in the at least one beam and being configured to map the at least one beam by a defined mapping, the defined mapping being configured to increase an image of an up-axis portion of the optical system imaged in the beam to a down-axis portion of the optical system.

10. The laser processing head of claim 9, wherein the at least one freeform refractive optic is positionable in the diverging beam between the fiber tip as the up-axis portion and the collimating stage as the down-axis portion, the at least one freeform refractive optic in the second position being configured to increase the image of the fiber tip imaged in the diverging beam to the collimating stage.

11. The laser processing head of claim 9, wherein the collimating stage has the changeable effective focal length; and wherein the at least one freeform refractive optic is positionable in the converging beam between at least an up-axis lens and a down-axis lens of the collimating stage, the at least one freeform refractive optic in the second position being configured to increase the image of the up-axis lens in the collimated beam to the down-axis lens.

12. The laser processing head of claim 9, wherein the focusing stage has the changeable effective focal length; and wherein the at least one freeform refractive optic is positionable in the converging beam between at least an up-axis lens of the collimating stage and a down-axis lens of the focusing stage, the at least one freeform refractive optic in the second position being configured to increase the image of the up-axis lens in the collimated beam to the down-axis lens.

13. A method of laser processing using laser energy from a fiber tip, the method comprising:
collimating, in a collimating stage, a diverging beam of the laser energy from the fiber tip into a collimated beam;
focusing, in a focusing stage, the collimated beam into a converging beam to a focus spot;
changing a changeable focal length of at least one of the collimating stage and the focusing stage;
operating in a first condition under the changeable effective focal length by placing a freeform refractive optic out of the optical axis between the fiber tip and the collimating stage to produce a first range of sizes of the focus spot; and
operating in a second condition under the changeable effective focal length by placing the freeform refractive optic in the optical axis between the fiber tip and the collimating stage, increasing an image of the fiber tip imaged in the diverging beam to the collimating stage by mapping the diverging beam by a defined mapping to produce a second range of sizes of the focus spot.

14. The method of claim 13, wherein placing the freeform refractive optic in and out of the optical axis comprises moving the freeform refractive optic between first and second positions relative to the optical axis by actuating an actuator associated with the freeform refractive optic.

15. The method of claim 13, wherein changing the changeable focal length comprises moving one or more lenses for at least the collimating stage along the optical axis.

16. The method claim 13, wherein changing the changeable focal length comprises moving one or more lenses for at least the focusing stage along the optical axis.

17. The method of claim 13, wherein the first range is configured to a deep penetration welding operation by the laser processing head, and wherein the second range is configured to a brazing operation by the laser processing head.

18. The method of claim 13, wherein the freeform refractive optic comprises a beam shaper having a non-uniform surface configured to diverge an incident beam at a defined divergence angle.

19. The method of claim 13, wherein mapping the diverging beam by the defined mapping to produce the second range of sizes of the focus spot comprises making the fiber tip appear larger to the collimating stage with the freeform refractive optic.
